(19) United States
(12) Patent Application Publication
(10) Pub. No.: US 2013/0107302 A1
(43) Pub. Date: May 2, 2013

(54) IMAGE PROCESSING APPARATUS, IMAGE PROCESSING METHOD AND MEMORY MEDIUM

(71) Applicant: CANON KABUSHIKI KAISHA, Tokyo (JP)

(72) Inventor: Takeshi Suzuki, Inagi-shi (JP)

(73) Assignee: CANON KABUSHIKI KAISHA, Tokyo (JP)

(21) Appl. No.: 13/633,719

(22) Filed: Oct. 2, 2012

(30) Foreign Application Priority Data
Oct. 28, 2011 (JP) 2011-236915

(51) Int. Cl. G06K 15/02

(52) U.S. Cl. 358/1.13

(57) ABSTRACT

The present invention provides an image processing apparatus that can easily print a sheet appropriate for a user to issue an instruction. The content of a read image obtained by a reading apparatus reading an original is determined. According to the content of the determined read image, a printing apparatus is caused to print, on a sheet, a sheet image corresponding to a sheet for executing a process on the read image of the original.

### BACKGROUND OF THE INVENTION

1. Field of the Invention

The present invention relates to an image processing apparatus, an image processing method and a memory medium that are for printing a sheet by which a user issues an instruction.

2. Description of the Related Art

It has been known that a multifunction apparatus or multifunction peripheral (hereinafter called “MFP”), which has a network function in addition to functions of a printer, a scanner, a card slot, a FAX, and so on, is connected to a server using the network function. The MFP can operate various functions on the server using server-side capabilities via the network.

A technology has been known that, in such a system, a user fills out a form sheet and causes a scanner to read the sheet so as to instruct a server in processing content. According to a system disclosed in Japanese Patent Application Laid-Open No. 2003-30774, after a sheet filled out by a user is read by a scanner, a read image thereof is sent to a server, and the server controls electronic apparatuses, such as an air conditioner and a television, based on the content filled out by the user in the sheet.

In the case where a user issues an instruction using a sheet as with the conventional art, the user is required to cause a printing apparatus to print a sheet based on processing content and functions that the user wishes to cause the apparatus to execute.

Unfortunately, for instance, in the case with many available functions on which a user can issue instructions, many types of sheets are required to support the functions. Accordingly, it is sometimes difficult for a user to print a desired type of sheet.

### SUMMARY OF THE INVENTION

The present invention provides an image processing apparatus that can easily print a sheet appropriate for a user to issue an instruction.

An image processing apparatus of the present invention, includes: an acquisition unit acquiring a read image obtained by a reading apparatus reading an original; a determination unit determining content of the read image acquired by the acquisition unit; and a print control unit causing a printing apparatus to print, on a sheet, a sheet image corresponding to a sheet for executing a process on the read image of the original according to the content of the read image determined by the determination unit.

Further features of the present invention will become apparent from the following description of exemplary embodiments with reference to the attached drawings.

### BRIEF DESCRIPTION OF THE DRAWINGS

FIG. 1 is a configurational diagram illustrating an image processing system IDS1 of this embodiment.

FIG. 2 is a block diagram illustrating a schematic configuration of a multifunction apparatus 100.

FIG. 3 is a block diagram illustrating a schematic configuration of a server 200.

FIG. 4 is a sequence diagram illustrating an operation of generating an appli navi-sheet (application navigation sheet).

FIG. 5 is a flowchart illustrating an operation of a process of analyzing a read image.

FIG. 6 illustrates an appli navi-sheet ANS1 when an image of an original is an “A4/document”.

FIG. 7 illustrates an appli navi-sheet ANS2 that is filled out on the appli navi-sheet ANS1.

FIG. 8 illustrates an appli navi-sheet ANS3 when an image of an original is “L-size/picture”.

FIG. 9 is a block diagram illustrating a multifunction apparatus 300 of this embodiment.

FIG. 10 is a flowchart illustrating an operation of the multifunction apparatus 300.

### DESCRIPTION OF THE EMBODIMENTS

Preferred embodiments of the present invention will now be described in detail in accordance with the accompanying drawings.

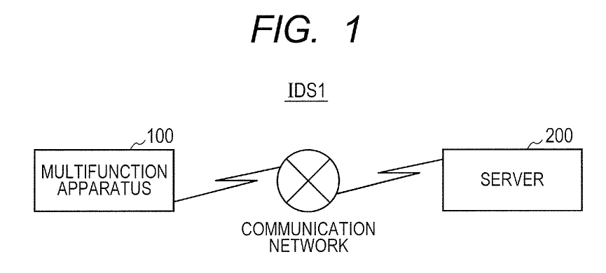

FIG. 1 is a configurational diagram illustrating an image processing system IDS1 of this embodiment.

The image processing system IDS1 includes a multifunction apparatus 100, as a terminal, and a server 200, which are connected to each other via a communication network. In the case of communication between the multifunction apparatus 100 and the server 200, control is executed according to HTTP. A publicly known method is used as a control protocol between the multifunction apparatus 100 and the server 200.

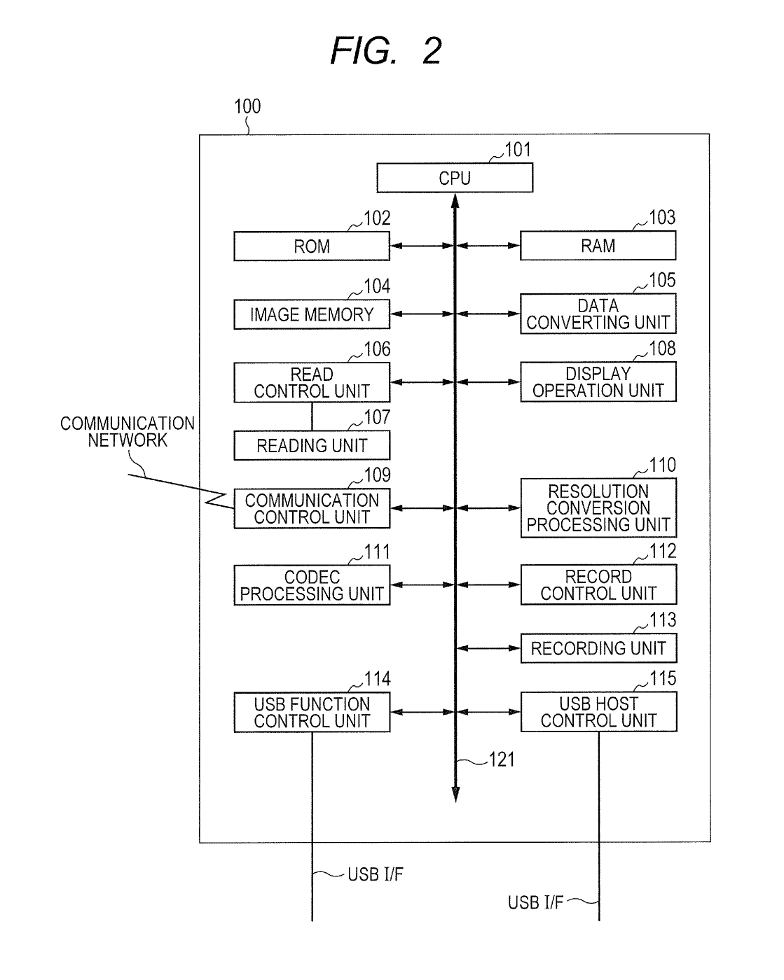

FIG. 2 is a block diagram illustrating a schematic configuration of the multifunction apparatus 100.

In the multifunction apparatus 100, a CPU 101 is a system control unit, and controls the entire multifunction apparatus 100. A ROM 102 stores fixed data, such as control programs executed by the CPU 101, data tables and an embedded operating system (OS) program. In this embodiment, each control program stored in the ROM 102 executes software executing controls, such as scheduling, task switching and interruption processes, under management of the embedded OS stored in the ROM 102.

The RAM 103 may include an SRAM (static random access memory) requiring a backup battery, and in the SRAM, data is held by a primary battery for data backup, which is not illustrated. The RAM 103 stores program control variables or the like, deletion of which data will cause a trouble. A memory area is also allocated to store setting values registered by an operator, a management data for the multifunction apparatus 100, and so on. An image memory 104 may include a DRAM (dynamic random access memory), and stores image data. A certain area is secured as a working area for executing process for software.

A data converting unit 105 converts image data; more specifically, this unit analyzes a page description language (PDL), and expands a character data into CG (computer graphics). A read control unit 106 causes an image process control unit, not illustrated, to apply various image processes, such as a binarization process and a halftone process, to an image signal acquired by causing a CIS image sensor to optically read an original and converting thus read data into an electric image data by means of a reading unit 107, and outputs a high definition image data.

The read control unit 106 and thereadg unit 107 may adopt any one of following two read control schemes. The first scheme is a sheet read control scheme that causes a fixed CIS image sensor to execute reading while conveying an original. The second scheme is a book read control scheme that causes a moving CIS image sensor to scan an original fixed on a platen. A display operation unit 108 includes: minimum necessary keys, such as numeric input keys, mode setting keys, a decide key and a cancel key; an LED (light emitting diode) and a seven segment display unit. A user can instruct the multifunction apparatus 100 by pressing a key included in the display operation unit 108. The multifunction apparatus 100 receives an instruction in response to pressing of the key by the user, and activates various functions based on the instruction.

The communication control unit 109 is connected to a communication network so as conduct connection to an Internet provider and to send and receive data and image information to and from the server 200. A publicly known method is used for connection to the communication network. The description thereof is omitted. The resolution conversion processing unit 110 controls resolution conversion, such as interconversion between a millimeter-defined image data and an inch-defined image data. Note that the resolution conversion processing unit 110 can also execute an enlargement/reduction process of image data. A codec processing unit 111 mutually encodes and decodes image data (such as uncompressed, MH, MR, MMR, JBIG and JPEG), which is dealt with in the multifunction apparatus 100, and executes the enlargement/reduction process of the image data.

A record control unit 112 applies various image processes, such as a smoothing process, a recording density correction process and a color correction, to image data to be printed via an image process control unit, not illustrated, to convert the image into a high definition image data, and outputs the data to a recording unit 113. That is, the record control unit 112 executes a print control of causing a printing apparatus to print an appli navi-sheet acquired by an appli navi-sheet acquisition unit. Furthermore, the record control unit 112 controls a USB host control unit 115 to periodically acquire a status information data on the recording unit 113.

The recording unit 113 may include a laser beam printer, an ink jet printer or the like, and prints one of a color image data and a monochrome image data generated by the record control unit 112 on a print medium. A USB function control unit 114 controls communication of a USB interface (I/F), and executes protocol control according to the USB communication standard. This unit converts data from a USB function control task executed by the CPU 101 into packets, and sends the USB packets to an external PC, not illustrated. Reversely, this unit converts USB packets from the external PC into data and sends the data to the CPU 101.

A USB host control unit 115 executes communication according to a protocol defined by the USB communication standard. The USB communication standard is a standard allowing fast bidirectional data communication, and can connect hubs or functions (slaves) to one host (master). The USB host control unit 115 has a function as a host in USB communication. The configurational elements 101 to 106 and 108 to 115 are connected to each other via a CPU bus 121 managed by the CPU 101.

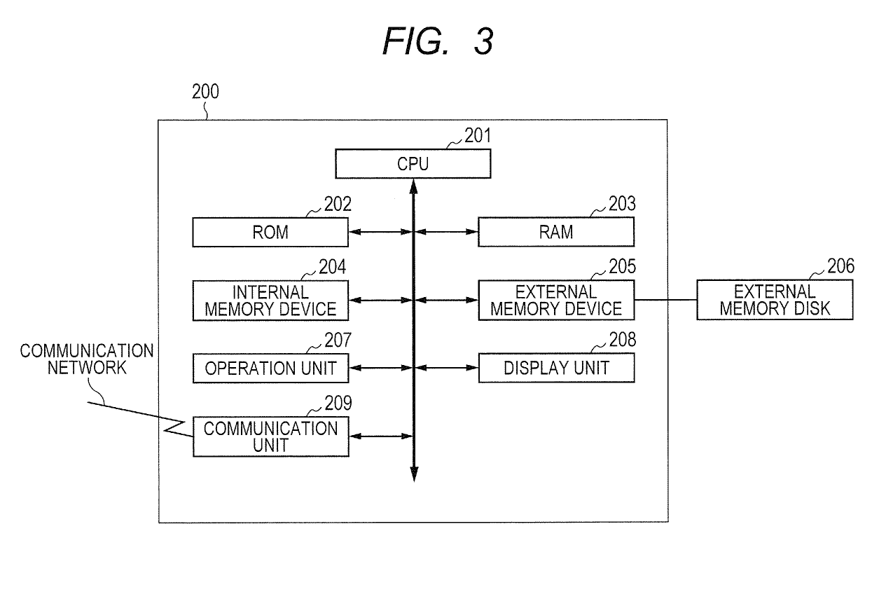

FIG. 3 is a block diagram illustrating a schematic configuration of the server 200.

The CPU 201 controls the entire operation of the server 200 via a system bus, according to a program read from one of a ROM 202, a RAM 203, an internal memory device 204, and an external memory disk 206 through an external memory device 205. The ROM 202 stores a control program for the CPU 201.

The RAM 203 temporarily stores a program and image data to allow processes of the server 200 to operate at high speed. The internal memory device 204 stores an operating system, various application programs, image data, and so on. Various control instructions for the multifunction apparatus 100, application software for sending and receiving data, and so on are installed in the internal memory device 204. The application software includes creating an appli navi-sheet.

The “appli navi-sheet” is a sheet which the user fills out to issue an instruction. After the sheet is read by the reading unit 107 of the multifunction apparatus 100, a process according to the content filled out on the sheet by the user is executed. In particular, this embodiment enables an instruction to be issued to the server 200 by the appli navi-sheet. For instance, after the sheet is read together with the original by the reading unit 107, a read image of the original is sent from the multifunction apparatus 100 to the server 200. The server 200, having received the read image, executes a process on the read image according to the content filled out on the sheet by the user.

For printing the appli navi-sheet, in this embodiment, application software of the server 200 creates a sheet image corresponding to the appli navi-sheet. The created sheet image is sent from a communication unit 209 to the multifunction apparatus 100. The multifunction apparatus 100 prints the sheet image received from the server 200, thus allowing the appli navi-sheet to be printed.

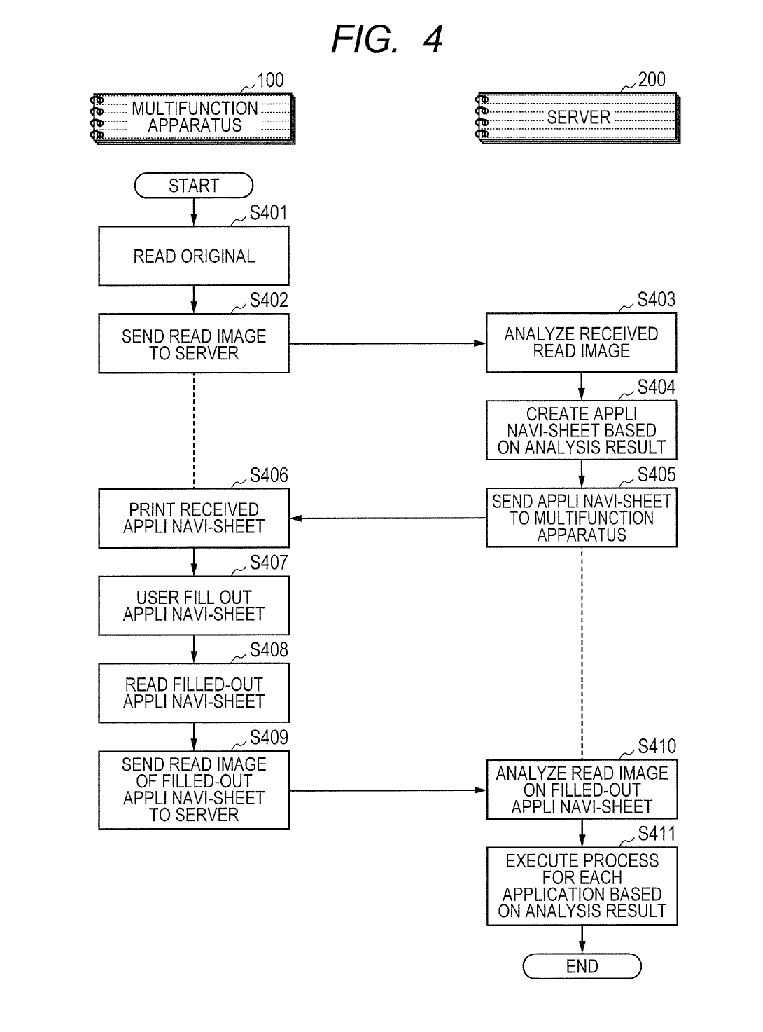

The server 200, which creates a sheet image as described above, can create types of sheet images corresponding to respective types of application software. This server creates a sheet image corresponding to the application software used by the user, and sends the sheet image to the multifunction apparatus 100. More specifically, an original is read by the reading unit 107 of the multifunction apparatus 100. The read image is sent to the server 200. The server 200 then identifies the content (type) and size of the original based on the read image. The server 200 creates a sheet image according to the content (type) and size of the identified original, and sends the sheet image to the multifunction apparatus 100. The details of the process of creating the sheet image will be described later using FIG. 4.

The process of creating a sheet image corresponding to the appli navi-sheet may be executed by an application for creating the appli navi-sheet or an application itself according to the type of the original. Furthermore, the technology is not limited to the case where the application software newly creates a sheet image. For instance, sheet images for respective types of sheets may be preliminarily stored in the internal memory device 204, and a sheet image corresponding to the type and size of the original may be read from the internal memory device 204 and sent to the multifunction apparatus 100.

Such application software is installed by receiving data from another computer-readable recording medium storing the application software through the external memory disk 206 (CD/DVD medium) and controlling the external memory device 205.

An operation unit 207 is a device operated by an operator, and is, for instance, a keyboard and a mouse (not illustrated). The operator can instruct the server 200 by operating the operation unit 207. In this embodiment, the server 200 includes the operation unit 207. However, an external operation device may be connected to the server 200.

A display unit 208 displays various screens for the operator. The communication unit 209 is connected to the communication network so as conduct connection to an Internet provider, and to send and receive data and image information to and from the multifunction apparatus 100. A publicly known method is used for connection to the communication network. The description thereof is omitted.

FIG. 4 is an entire sequence diagram illustrating an operation of generating an appli navi-sheet.

First, the user operates the display operation unit 108 of the multifunction apparatus 100 and issues instructions for reading by the reading unit 107 and for sending a read image obtained by the reading to the server 200. In S401, the read control unit 106 and thereadg unit 107 are used to read originals, such as a picture and a document, which is placed on a platen or an ADF, not illustrated, and which the user wishes to process. Subsequently, in S402, the communication control unit 109 is used to send read image read S401 to the server 200.

At this time, various pieces of information, such as information for identifying the multifunction apparatus 100 (serial number, a MAC address, an account, a password, etc.), language information and destination information may be simultaneously notified to the server.

Meanwhile, the server 200 causes the communication unit 209 to receive the read image read by the multifunction apparatus 100 in S401. Subsequently, in S403, the received read image is analyzed using an image analysis application stored in the internal memory device 204, and the type of the original corresponding to the read image is determined.

Subsequently, in S404, the server 200 creates a sheet image corresponding to the appli navi-sheet according to the type of the original determined in S403, using an application for creating an appli navi-sheet that is stored in the internal memory device 204. In this embodiment, functions in which an instruction can be issued using the appli navi-sheet to be created at this time include common functions irrespective of the types of the originals and functions added according to the types of the originals. More specifically, four functions, i.e. “mail send”, “fax send”, “save to memory card”, “save to folder on network” on a read original, can be commonly designated irrespective of the types of the originals. Fields for designating the respective functions are included in the sheet.

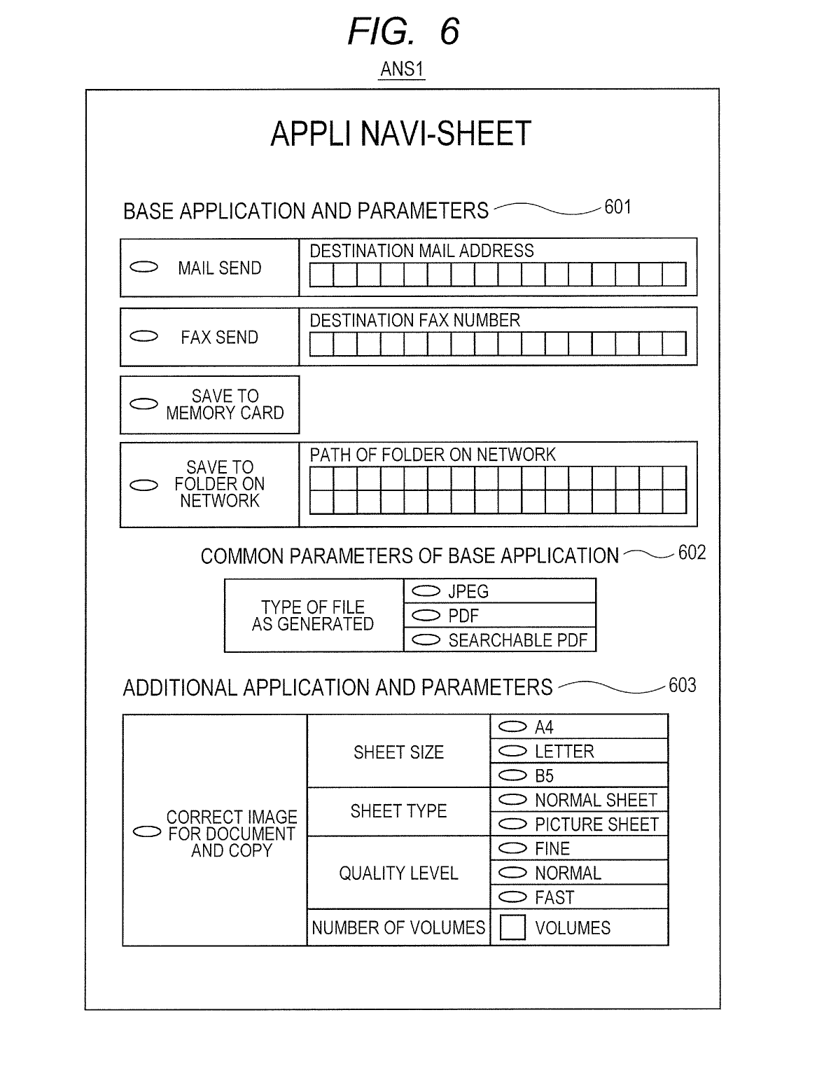

Meanwhile, one of the functions according to the types of the originals is a function of uploading a picture to a picture sharing site. If it is determined that the type of the original is a picture, a field for designating this uploading function is included in the appli navi-sheet. If it is determined that the type of the original is a document, a field for designating image correction and copying of a document is included in the appli navi-sheet. The content included in the appli navi-sheet will be described later using FIGS. 6 to 8.

Instead of creation and acquisition of an appli navi-sheet in S404, a plurality of appli navi-sheets may preliminarily be stored in the ROM 202, and an appli navi-sheet according to the result of the image analysis in S403 may be selected from the ROM 202 and acquired. That is, in S404, appli navi-sheet acquisition is executed that creates or selects one appli navi-sheet from among the appli navi-sheets to acquire the sheet.

In the above description, the functions independent of the type of the original are “mail send”, “fax send”, “save to memory card” and “save to folder on network”. However, the functions may be another function. Furthermore, in S402, the language information and destination information of the multifunction apparatus 100 may be received together with the image of the original, and an appli navi-sheet may be created in a language suitable for the user. Moreover, the format of the appli navi-sheet created in S404 may be any format supported by the multifunction apparatus 100. For instance, this format may be of an image, such as JPEG, and may be described in a page description language, such as PDF.

Subsequently, in S405, the sheet image of the appli navi-sheet created in S404 is sent to the multifunction apparatus 100 using the communication unit 209.

Meanwhile, the multifunction apparatus 100 causes the communication control unit 109 to receive the sheet image of the appli navi-sheet from the server 200. Then, in S406, using the record control unit 112, the multifunction apparatus 100 prints the received sheet image of the appli navi-sheet. Subsequently, in S407, the user refers to the printed appli navi-sheet, selects applications and parameters that the user wishes to use, and fills out the appli navi-sheet. Next, in S408, the user places the filled-out appli navi-sheet on the platen or ADF, not illustrated, operates the display operation unit 108 to issue instructions of reading the sheet and sending the read image. The read control unit 106, using the reading unit 107, reads the appli navi-sheet.

Subsequently, in S409, the communication control unit 109 is used to send the read image of the filled-out appli navi-sheet read S408 to the server 200. At this time, various pieces of information, such as information for identifying the multifunction apparatus 100 (a serial number, a MAC address, an account, a password, etc.), language information and destination information may be simultaneously notified to the server. Meanwhile, the server 200 causes the communication unit 209 to receive the read image of the filled-out appli navi-sheet from the multifunction apparatus 100.

Subsequently, in S410, the server 200 analyzes the received read image of the filled-out appli navi-sheet using an appli navi-sheet analysis application stored in the internal memory device 204. One of publicly known methods, such as a mark sheet technology and an OCR technology, is used for analyzing the read image. The description thereof is omitted. In the case where the appli navi-sheet analysis application recognizes the type of an unfilled appli navi-sheet, information for identifying the multifunction apparatus 100 may be used for the recognition. Instead, when the appli navi-sheet is created in S404, information for identifying the content of the appli navi-sheet (e.g., a barcode or a QR code) may be described on the appli navi-sheet. Finally, in S411, according to the type of the original determined based on the analysis result on the appli navi-sheet in S410, the server 200 activates the application that corresponds to the type of the original and is stored in the internal memory device 204.

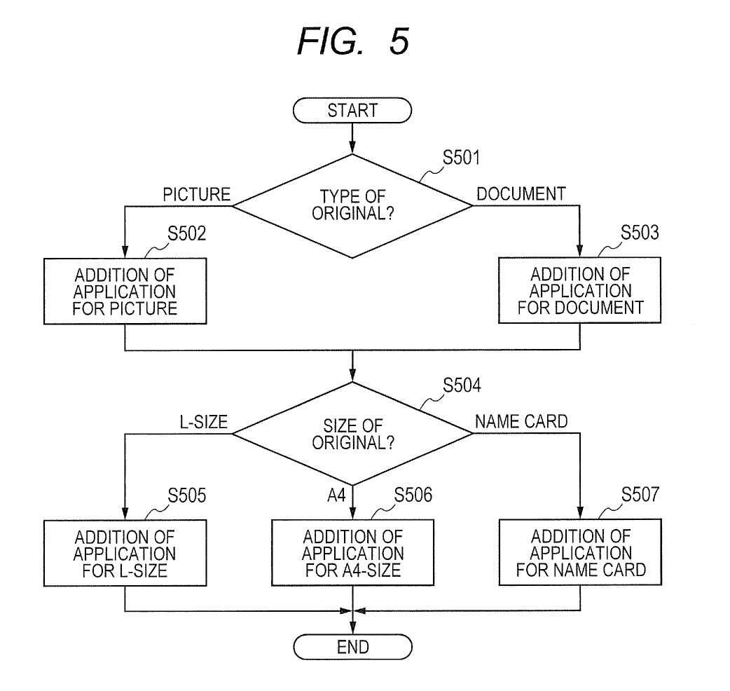

FIG. 5 is a flowchart illustrating an operation of a process of analyzing the read image by the server 200 in S403 in FIG. 4. First, in S501, the server 200 determines the type of the original of the read image received from the multifunction apparatus 100. A publicly known method is used for determining the type of original. The description thereof is omitted.

As a result of the determination of the type of the original in S501, if the type of the original is a picture, an application for a picture is added as a candidate for applications to be described on the appli navi-sheet in S502. For instance, an application of extra printing (“correct image for picture and copy”), “upload to picture sharing site”, or the like is added. Meanwhile, as the result of determination of the type of the original, if the type of the original is a document, an application for a document is added as a candidate for applications to be described on the appli navi-sheet in S503. For instance, an optional setting of “apply OCR process to generated PDF file to generate searchable PDF” may be added, an application of “correct image for document and copy”, or the like is added.

Subsequently, in S504, the server 200 determines the original size of the received read image. As a result of the determination on the original size, if the original size is the L-size, the processing proceeds to S505; if the size is the A4, the processing proceeds to S506; if the size is of a name card, the processing proceeds to S507. An application suitable for each image size is added as a candidate for applications to be described on the appli navi-sheet. For instance, if the original size is of a name card, an application, such as “register name card information in name card management application managing name card information for each user operating on server” is added. In this case, the user is required to be identified in S402. Accordingly, information for identifying the multifunction apparatus 100 (a serial number, a MAC address, an account, a password, etc.) is required to be sent to the server 200. The read image received in S403 is sometimes used to execute the application in S411. Accordingly, this image is stored in the internal memory device 204.

FIG. 6 is a diagram illustrating an example of an appli navi-sheet ANS1 created by the server 200 in the case where the process in FIG. 5 has determined that the size and type of the original are “A4/document”.

In the fields for a base application 601 on the appli navi-sheet ANS1, four applications are described irrespective of the result of the image analysis, and parameters for each application. In the field for common parameters 602, a common parameter is described for using the base applications are described. Here, a file format can be designated as the common parameter. If “save to memory card” or “save to folder on network” is selected as a function executed by the user, a file of the type designated by the “common parameters” is generated and stored in a folder corresponding to the function.

According to the result of the analysis in S403, if the image of the original is determined as a document, an item of “searchable PDF” is described as the common parameter of type of file as generated. According to the result of the analysis in S403, if the image is determined as a picture, the item of “searchable PDF” is not described.

According to the result of the analysis in S403, if the image of the original is determined as an A4/document, a field for designating an application of “correct image for document and copy” is described in a field for an additional application 603. Thus, the user causes the reading unit 107 of the multifunction apparatus 100 to read the original of the document. Accordingly, the user can acquire a sheet capable of instructing image correction for a document.

The user is required to select any one application from the base application 601 and the additional application 603 and to describe the application. Furthermore, the user is required to fill out the field for necessary parameters. However, the user may designate a plurality of applications, and processes according to the respective applications may be executed on the read image.

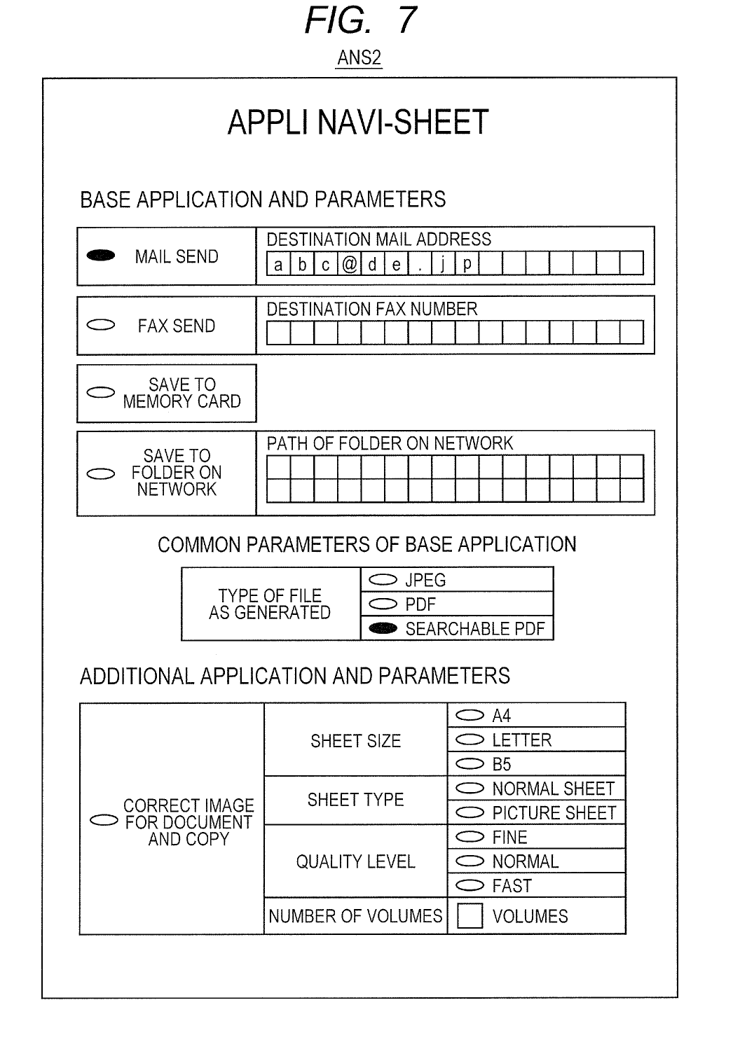

FIG. 7 is a diagram illustrating an example of a filled-out appli navi-sheet ANS2 where the user has filled out the appli navi-sheet ANS1 having been received from the server 200. If the read image of the appli navi-sheet ANS2 illustrated in FIG. 7 is received by the server 200 in S410, the appli navi-sheet analysis application executes following recognition. That is, the application recognizes that the application designated by the user is “mail send”, the destination mail address is “abc@de.jp” and the common parameter is “searchable PDF”. The server 200 then activates the application of “mail send”.

The application of “mail send” in the server 200 converts the read image, having been received from the multifunction apparatus 100 and saved in the internal memory device 204 in S403, into a searchable PDF. The searchable PDF file is attached to an email, which is transmitted to an email address of abc@de.jp. Publicly known methods are used for the method of conversion into a searchable PDF and a method of sending an email. The description thereof is omitted.

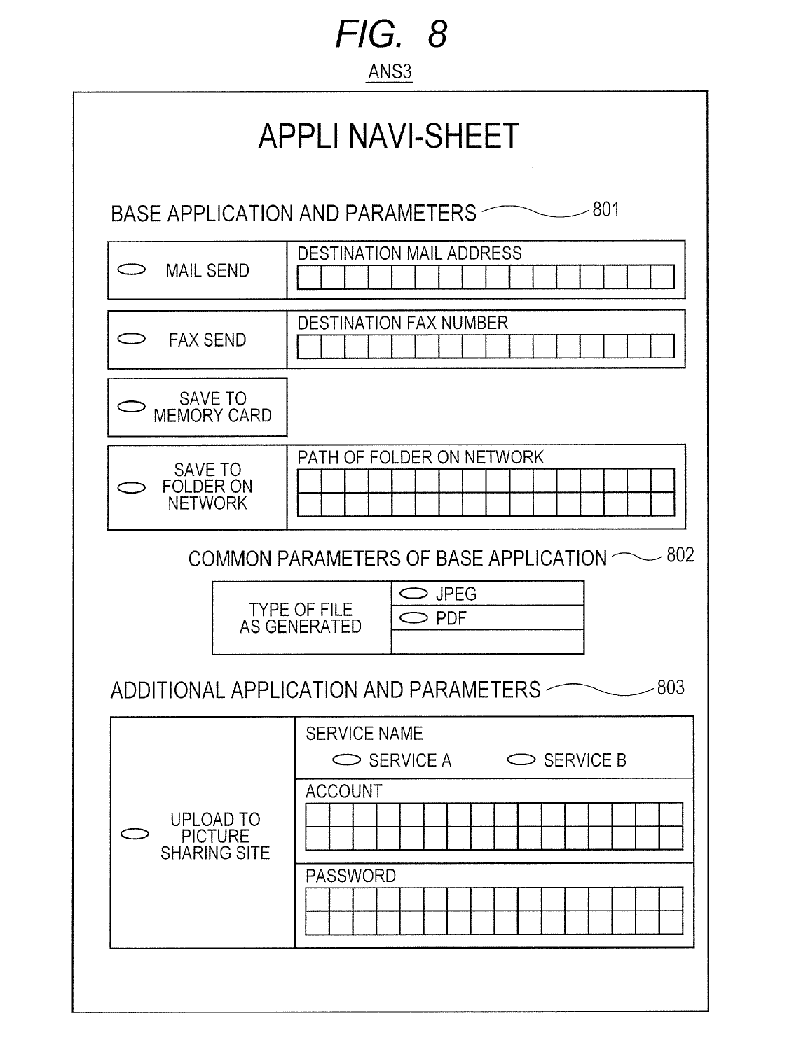

FIG. 8 is a diagram illustrating an example of an appli navi-sheet ANS3 created in the case where the server 200 determines that the size and type of the original are “L-size/picture” in the process in FIG. 5.

Fields for a base application 801 and common parameters 802 on the appli navi-sheet ANS3 are common to those in the case where the original is a document. The respective fields are identical to the fields for the base application 601 and the common parameters 602 illustrated in FIG. 6. Accordingly, the description thereof is omitted.

Here, the type of the original read by the multifunction apparatus 100 has been determined as a picture. Accordingly, in a field for additional application 803 on the appli navi-sheet ANS3, an application of “upload to picture sharing site” is described. Accordingly, the user causes the multifunction apparatus 100 to read the original of a picture and allows this apparatus, using the “picture sharing site”, to upload the read image of the original of the picture to the site, which is a service according to the original of the picture.

In the case where the user uses the picture sharing site, the user is required to input an account and a password registered in the picture sharing site and to be authenticated by the site. Thus, the appli navi-sheet illustrated in FIG. 8 is provided with fields for describing an account and a password for the picture sharing site. After the user fills out the account and the password in this field and causes the multifunction apparatus 100 to read the content, the account and the password filled out on the sheet by the user are acquired by the server 200 in S410. In S410, the application for access to the picture sharing site sends the account and the password to a server of the picture sharing site. This server executes authentication. After the user authentication, the read image having been received from the multifunction apparatus 100 in S403 is sent to the server of the picture sharing site so as to cause the server to store the read image.

In the examples illustrated in FIGS. 6 and 8, the appli navi-sheet is realized as one sheet. However, in the case where many applications are used and cannot be accommodated in one sheet, an appli navi-sheet including multiple sheets may be used. In each of the fields for the additional application 603 and the additional application 803, one application and one parameter are described. Instead, two or more additional applications may be described.

For instance, even in the case of sending the image of an original of “A4/document”, there is a possibility that a user exists who wishes to use the application “upload to picture sharing site” on appli navi-sheet ANS3 illustrated in FIG. 8. Accordingly, in the case of describing an alternative of “print sheet with all additional applications”, not illustrated, a function may be included that prints a sheet describing all the additional applications irrespective of the result of the image analysis illustrated in FIG. 5.

According to the embodiment, after the original is read by the reading apparatus, the type and size of the original are determined and a sheet according to the determined type and size is printed. The sheet is filled out by the user, and read by the reading apparatus, allowing a process for the read image of the original to be executed.

Accordingly, in the embodiment, the user easily acquires a sheet for executing functions of processing the read image of the original corresponding to the original, by causing the reading apparatus to read the original. Furthermore, in the embodiment, various applications realized by connection with a server can be used, using the printed form sheet.

In the above embodiment, after the multifunction apparatus 100 reads the original or the appli navi-sheet, the read image of one of the original and the sheet is sent to the server 200, and the server 200 analyzes the read image, creates a sheet image and executes the application software. However, the configuration is not limited thereto. Instead of the server 200, at least any one of external apparatuses, such as a second server, a second multifunction apparatus and a PC connected to the multifunction apparatus 100, which are not illustrated, may be used. Instead of the multifunction apparatus 100, a terminal apparatus may be used; instead of the server 200, an external apparatus other than the terminal apparatus may be used.

In the embodiment, both the type (content) and size of the original are determined based on the read image, and the appli navi-sheet based on the determination result is printed. However, the technology is not limited thereto. Any of the content and the size may be determined, and the sheet may be printed based on the determination result.

Furthermore, without limitation to the type and size of the original, the number of original sheets may be determined, and a type of an appli navi-sheet based on the number of original sheets may be printed. For instance, if it is determined that one sheet has been read as a result of analysis on the read image, a sheet for storing the read image of the original as a JPEG file in the memory is printed. Meanwhile, if it is determined that a plurality of sheets has been read, a sheet for creating a multi-page file, such as a PDF file, is printed. In the case of determining the number of sheets based on the content of the read image as described above, the number of read images may be regarded as the number of sheets; instead, the area of the originals may be identified by analyzing the read image and the number of sheets included in the read image may be identified.

Various determination methods can be adopted for determining the size of the original. For instance, the server 200 may acquire the read image of the entire surface of the platen and identify the area of the original in the read image by edge determination so as to determine the size of the original. Instead, the server 200 may acquire the size of the original detected by a sensor for the size of an original included in the MFP. The server 200 may acquire, from the MFP, information indicating the size of the original set when the user has caused the MFP to read the original, and identify the size of the original indicated by the information.

On the sheet in the embodiment, the user fills out mark fields to issue an instruction. However, the technology is not limited thereto. For instance, characters filled out by the user may be character-recognized based on a read image, and a process may be executed according to the content thereof. Instead of filling out by the user, stickers may be put. That is, the user may add information onto a sheet, and a process may be executed based on the information. The form of adding information is not limited.

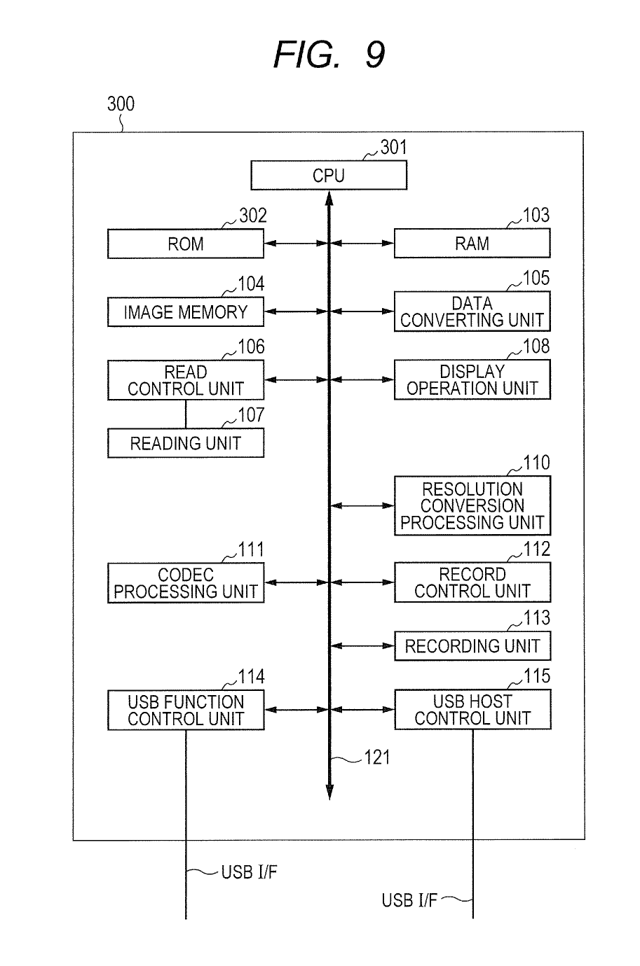

FIG. 9 is a block diagram illustrating a multifunction apparatus 300 of this embodiment.

The configuration of the multifunction apparatus 300 is basically the same as the configuration of the multifunction apparatus 100. However, the multifunction apparatus 300 has the functions of the multifunction apparatus 100 and the functions of the server 200 in the image processing system IDS1. That is, the multifunction apparatus 300 itself reads an original and an appli navi-sheet, analyzes a read image, creates and prints a sheet image, and executes application software. In this embodiment, the multifunction apparatus is not required to communicate with a server, which negates the need of a communication function analogous to the communication function between the multifunction apparatus 100 and the server 200.

In the multifunction apparatus 300, a CPU 301 creates and acquires one appli navi-sheet among appli navi-sheets that are to be filled out by the user for realizing functions corresponding to the read image read by the reading unit 107. The CPU 301 then causes the recording unit 113 to print the acquired appli navi-sheet.

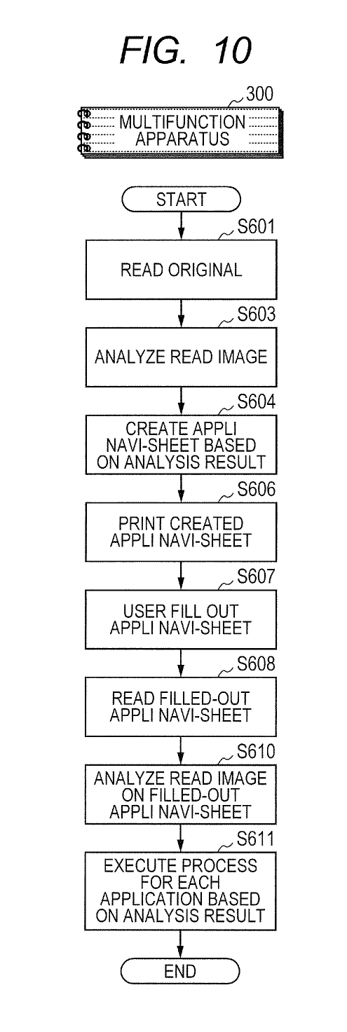

FIG. 10 is a flowchart illustrating an operation of the multifunction apparatus 300.

In S601, the original is read S603, the read read original is analyzed. In S604, the appli navi-sheet based on the analysis result is created and acquired. In S606, the created appli navi-sheet is printed. In S607, the user fills out the printed appli navi-sheet. In S608, the filled-out appli navi-sheet is read S610, the read read image of the filled-out appli navi-sheet is analyzed. In S611, processes of the respective applications based on the analysis result are executed.

Instead of creation and acquisition of the appli navi-sheet in S604, a plurality of appli navi-sheets may preliminarily be stored in a ROM 302 or the like, and an appli navi-sheet based on the result of image analysis may be selected from the ROM 302 or the like and acquired.

The embodiment may be realized by executing a following process. More specifically, as to the process, software (program) to realize the functions of the embodiment may be supplied to the system or the apparatus via one of a network and various memory media; a computer (or CPU or MPU) in the system or the apparatus may read and execute the program. The program may be executed by one computer (CPU or MPU) or by cooperation of computers.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-236915, filed Oct. 28, 2011, which is hereby incorporated by reference herein in its entirety.

What is claimed is:

1. An image processing apparatus, comprising:
an acquisition unit which acquires a read image obtained by a reading apparatus reading an original;
a determination unit which determines content of the read image acquired by the acquisition unit; and
a print control unit which causes a printing apparatus to print, on a sheet, a sheet image corresponding to a sheet for executing a process on the read image of the original according to the content of the read image determined by the determination unit.

2. The image processing apparatus according to claim 1, further comprising:
a second acquisition unit which acquires a read image obtained by the reading apparatus reading the sheet which has been printed by the print control unit and to which a user adds information; and
an execution unit which executes a process corresponding to the sheet, on the read image of the original, based on the information that has been added to the sheet by the user and included in the read image acquired by the second acquisition unit.

3. The image processing apparatus according to claim 2, further comprising
a storing control unit which stores, into a memory, the read image which has been acquired by the acquisition unit and whose content has been determined by the determination unit,
wherein the execution unit executes the process on the read image stored in the memory by the storing control unit.

4. The image processing apparatus according to claim 1,
wherein the print control unit reads, from a memory, a sheet image corresponding to the content of the read image determined by the determination unit, from among sheet images corresponding to respective types of sheets preliminarily stored in the memory, and causes the printing apparatus to print the read sheet image.

5. The image processing apparatus according to claim 1,
wherein the print control unit newly creates a sheet image based on the content of the read image determined by the determination unit, and causes the printing apparatus to print the created sheet image.

6. The image processing apparatus according to claim 1,
wherein the determination unit determines at least one of a type, a size, and the number of sheets of the original, based on the read image of the original, and the print control unit causes the printing apparatus to print the sheet image corresponding to at least one of the type, the size, and the number of sheets of the original determined by the determination unit.

7. The image processing apparatus according to claim 1,
wherein the acquisition unit acquires the read image from an external reading apparatus connected to the image processing apparatus via a network, and the print control unit causes a printing apparatus connected to the image processing apparatus via the network to print an image.

8. An image processing method, comprising:
acquiring a read image obtained by a reading apparatus reading an original;
determining content of the read image acquired in the acquiring; and
print controlling by causing a printing apparatus to print, on a sheet, a sheet image corresponding to a sheet for executing a process on the read image of the original according to the content of the read image determined by the determining.

9. A memory medium in which a program is stored for causing a computer to execute the image processing method according to claim 8.
